(19) United States
(12) Patent Application Publication
(10) Pub. No.: US 2024/0327154 A1
(43) Pub. Date: Oct. 3, 2024

(54) PRINTING DEVICE

(71) Applicant: SEIKO EPSON CORPORATION, Tokyo (JP)

(72) Inventor: Yuki INOUE, SHIOJIRI-SHI (JP)

(21) Appl. No.: 18/617,403

(22) Filed: Mar. 26, 2024

(30) Foreign Application Priority Data
Mar. 29, 2023 (JP) 2023-052906

(51) Int. Cl. B65H 5/06; B41J 15/04; B41J 29/02

(52) U.S. Cl. CPC B65H 5/062; B41J 15/04; B41J 29/02; B65H 2404/143; B65H 2404/15

(57) ABSTRACT

A printing device 1 includes a transport roller pair 60 that sandwiches a print medium and that transports the print medium in a transport direction F, a first side frame 44, a second side frame 46. The transport roller pair 60 has a transport roller 50, a first rotation shaft that is a rotation shaft of the transport roller 50, a driven roller 54 that is located at a position facing the transport roller 50, a second rotation shaft that is a rotation shaft of the driven roller 54, an arm section 56 that holds rotatably the second rotation shaft, and an arm support shaft 62 that extends along a direction in which the second rotation shaft extends and supports the arm section 56. The transport roller 50 and the arm support shaft 62 are arranged parallel to each other in a longitudinal direction, by the first side frame 44 positioning one end portion of the arm support shaft in the longitudinal direction and by the second side frame 46 positioning an other end portion of the arm support shaft in the longitudinal direction.

The present application is based on, and claims priority from JP Application Serial Number 2023-052906, filed Mar. 29, 2023, the disclosure of which is hereby incorporated by reference herein in its entirety.

### BACKGROUND

### 1. Technical Field

The present disclosure relates to a printing device.

### 2. Related Art

In the related art, a printing device provided with a transport roller pair that transports a print medium to a printing section that performs printing is known. For example, JP-A-2017-226449 discloses a printing device with, as a transport roller pair, a feed roller upper, which is a roller that rotates under drive force from a drive source, and a feed roller lower, which is a roller that contacts and follows the feed roller upper. In this printing device, the print medium is sandwiched between the feed roller upper and the feed roller lower, and the print medium is transported by the rotational drive of the feed roller upper. Both of the feed roller upper and the feed roller lower extend in a direction whose longitudinal direction intersects the transport direction of the print medium. The feed roller upper and the feed roller lower are each supported by different support members.

In the printing device described in JP-A-2017-226449, the feed roller upper and feed roller lower may be supported by the support members in a state where they intersect with each other due to mounting errors or other reasons. In such a case, there will be a difference in the transport path length along the longitudinal directions of the feed roller upper and feed roller lower. Therefore, when printing on the print medium transported by the transport section, there is a concern that the printing device may cause printing deviations to the print medium.

### SUMMARY

An aspect of solving the above problem is that a printing device includes a transport roller pair that sandwiches a print medium and that transports the print medium in a transport direction; a first side frame; and a second side frame; wherein the transport roller pair includes a transport roller, a first rotation shaft that is a rotation shaft of the transport roller, a driven roller that is located at a position facing the transport roller, a second rotation shaft that is a rotation shaft of the driven roller, an arm section that rotatably holds the second rotation shaft, and an arm support shaft that extends along a direction in which the second rotation shaft extends and that supports the arm section, and the transport roller and the arm support shaft are arranged parallel to each other in a longitudinal direction, by the first side frame positioning one end portion of the arm support shaft in the longitudinal direction and by the second side frame positioning an other end portion of the arm support shaft in the longitudinal direction.

### BRIEF DESCRIPTION OF THE DRAWINGS

FIG. 1 is a perspective view of the printing device as viewed from the back side.

FIG. 2 is a side view of a main section showing the various sections related to the transport path of the printing device.

FIG. 3 is a cross-sectional view of the printing device that is cut at plane III of FIG. 1.

FIG. 4 is a side view of the first side frame as viewed from the left side.

FIG. 5 is a perspective view of a longitudinal cross-section of the printing device that is cut at plane V in FIG. 1.

FIG. 6 is a perspective view showing the transport roller pair and platen.

FIG. 7 is a perspective view showing the transport roller pair 60.

### DESCRIPTION OF EMBODIMENTS

Hereinafter, embodiments in this disclosure will be described with reference to the figures. In the description, the front and back, left and right, and up and down directions are the same as the direction with respect to the printing device 1, unless otherwise noted. In addition, a symbol FR shown in each figure indicates a front side of the printing device 1, a symbol UP indicates an upper side of the printing device 1, and a symbol RH indicates a right side of the printing device 1.

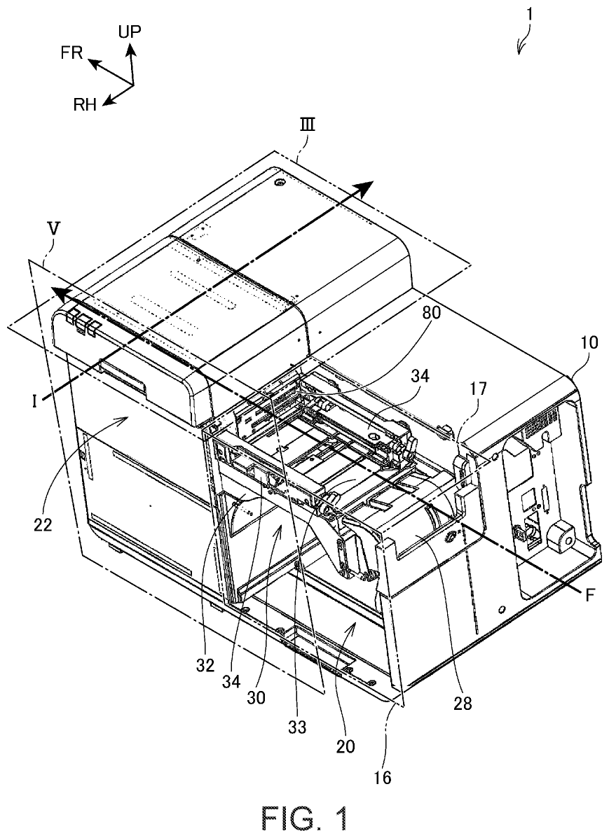

FIG. 1 is a perspective view of the printing device 1 as viewed from the back side. In FIG. 1, the upper cover 17 is shown in two dotted line for convenience of description. In FIG. 1, the transport direction F and the intersection direction I are indicated by a single dotted line for convenience of description. As described later, the printing device 1 is a so-called line-type inkjet printer, which is equipped with a line-shaped inkjet head and which ejects ink from the inkjet head to print characters and images on the print medium.

The print medium used for printing in the printing device 1 is a cut sheet that is cut into a predetermined size or a continuous sheet. These sheets are formed of paper, synthetic resin, or the like. These sheets may be, for example, coated fine paper with a front surface finish that enhances ink absorbency and fixation, suitable for inkjet-type printing.

The continuous sheet is, for example, a roll paper that is accommodated in the printing device 1 in a rolled state, or a fanfold paper that is supplied to the printing device 1 from outside the printing device 1 in a folded state. In addition to plain paper or fine paper rolled into a roll shape, label paper may be used as roll paper, in which standard-size labels with adhesive on the reverse side are arranged on peel-away paper, which is the base paper, and rolled into a roll shape.

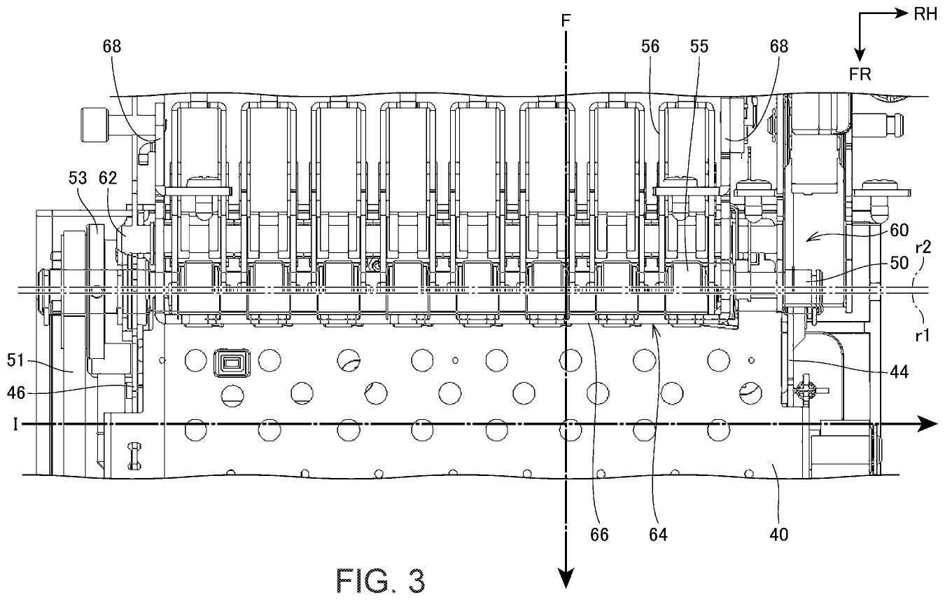

In this embodiment, label paper 100 is used as the print medium. In the label paper 100, a label of a predetermined size with adhesive applied to the back surface thereof is arranged on a base paper on which a peel-away paper, which is peelable from the adhesive, is formed in an elongated shape, and the label paper 100 is wound in a roll shape. In the label paper 100, a plurality of labels are arranged at equal intervals in the longitudinal direction of the base paper. The printing device 1 transports the label paper 100 and prints characters and images on the print surface of each label on the label paper 100. In other words, the printing device 1 is a label printer. In this case, the label paper 100 corresponds to a “print medium”. The label paper 100 is shown in FIG. 3 (to be described later).

The printing device 1 has a device case 10, which is a substantially rectangular parallelepiped housing. The device case 10 is an outer section that forms an outer shell of the printing device 1 by assembly of a side panel, a front panel, and the like.

On the right side surface of the device case 10, a paper cover 16, which can open and close, is provided at the lower backward portion of the device case 10. An accommodation section 20 that accommodates the label paper 100 is provided inside the paper cover 16. By opening the paper cover 16 of the printing device 1, the label paper 100 wound in a roll shape can be set into the accommodation section 20. In the device case 10, an upper cover 17 is provided from the upper portion of paper cover 16 to the upper surface of the device case 10. The upper cover 17 is configured to open and close, and to pivot around a hinge that is located at substantially the center of the upper surface of the device case 10. In the printing device 1, by opening the upper cover 17, the user can access the inside of the device case 10 from the outside and can perform various operations regarding the accommodation section 20 and the transport section.

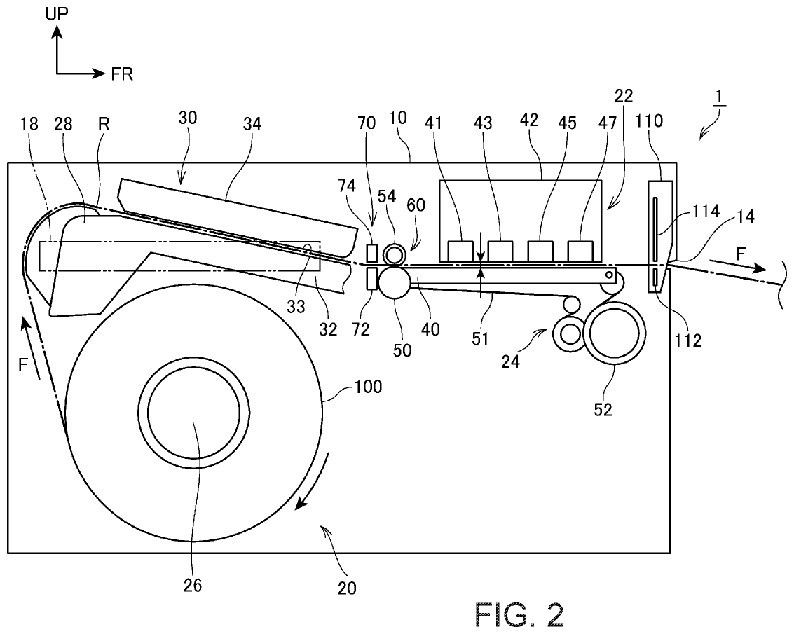

On the front surface of the device case 10, a slit-shaped paper discharge slot 14 extending in the left and right direction is formed substantially at the right side of the center when viewed from the front surface side. In the printing device 1, the printed label paper 100 is discharged from the paper discharge slot 14. The paper discharge slot 14 is shown in FIG. 2 to be described later.

FIG. 2 is a side view of a main section showing each section related to the transport path R of the printing device 1. As shown in FIG. 3, the printing device 1 has the accommodation section 20 that accommodates the label paper 100, a printing section 22 that performs printing on the label paper 100, and a transport section 24 that transports the label paper 100 from the accommodation section 20 to the printing section 22. In the printing device 1, the accommodation section 20 is provided on the rear side of the printing device 1, and the printing section 22 is provided on the front side of the accommodation section 20. The transport section 24 is provided below the printing section 22.

The accommodation section 20 has a roll shaft 26 on which the label paper 100 is set. The roll shaft 26 is a rod-shaped member that is rotatable in the circumferential direction. The label paper 100 is stored in the accommodation section 20 by inserting the roll shaft 26 into the center of the roll of the label paper 100. The roll shaft 26 may be connected to a drive device, for example, a motor, and may rotate with the drive of the drive device. In the printing device 1, the label paper 100 rotates with the rotation of the roll shaft 26.

The printing device 1 has a transport path R along which the label paper 100 attached to the roll shaft 26 is drawn out and transported to the paper discharge slot 14. A tension lever 28 is mounted above the label paper 100 that is stored in the accommodation section 20 in the transport path R. As shown in FIGS. 1 and 2, the tension lever 28 is formed in a cylindrical shape that has a curved surface in the circumferential direction and that extends in the left and right direction. The tension lever 28 applies tension to the label paper 100 to prevent slack. One end of the label paper 100 is pulled out upward, contacts the tension lever 28, is bent by the tension lever 28, and then extends forward.

As shown in FIGS. 1 and 2, a paper guide unit 30 is provided in front of the tension lever 28. The paper guide unit 30 guides the label paper 100 forward and also suppresses skewing of the label paper 100 and deviation in the transportation of the label paper 100. The paper guide unit 30 has a lower guide member 32 that supports the label paper 100 from below and a paper pressing member 34 that is located on the upper surface side of the label paper 100.

The lower guide member 32 has a flat surface 33 that extends in the front and back direction. The flat surface 33 has a width dimension longer than the width dimension of label paper 100 along the left and right direction. The label paper 100 is placed on and supported by the flat surface 33 of the lower guide member 32. The paper pressing member 34 is located above the label paper 100 facing the lower guide member 32 and prevents the label paper 100 from lifting up. The label paper 100 is transported in a state of being sandwiched between the lower guide member 32 and the paper pressing member 34 in the paper guide unit 30.

The printing section 22 for printing on the label paper 100 is provided in front of the paper guide unit 30. The printing section 22 has a platen 40 and a print head 42. The print head 42 in this embodiment ejects inks of four colors of C (cyan), M (magenta), Y (yellow), and K (black) to form dots on the print surface of the label. The print head 42 has a nozzle section 41 that ejects K (black) ink, a nozzle section 43 that ejects C (cyan) ink, a nozzle section 45 that ejects M (magenta) ink, and a nozzle section 47 that ejects Y (yellow) ink. In the nozzle sections 41 to 47, a plurality of nozzles for ejecting ink are arranged in a row in the width direction of the label paper 100. The nozzles of the nozzle sections 41 to 47 are arranged along intersection direction I, which intersects the transport direction F. In this embodiment, the intersection direction I is a direction that is orthogonal to the transport direction F. The intersection direction I coincides with the width direction of the label paper 100.

The print head 42 is a line inkjet head that can eject ink without scanning in the width direction of the label paper 100. Therefore, the nozzle array of the nozzle sections 41 to 47 are formed at least as wide as or wider than a printable area of the label paper 100. In this embodiment, the printable area corresponds to the print surface of the label. In this embodiment, an example configuration is described in which the nozzle sections are located in the order of nozzle sections 41, 43, 45, and 47 along the transport direction F of the label paper 100. However, the order in which the nozzle sections of each color are arranged in the transport direction F may be arbitrary.

The platen 40 has a flat surface which is arranged parallel to the transport direction F and to the intersection direction I. This flat surface is located below the transport path R and faces the print head 42. The nozzle sections 41 to 47 and the platen 40 are located with a gap between them, which is a so-called platen gap. The platen 40 has a flat upper surface that supports the label paper 100 from below. The platen 40 is provided over at least the entire print area in the printing section 22. The upper surface of the platen 40 is located substantially horizontally in the installed state and the use state of the printing device 1.

FIG. 3 is a cross-sectional view of the printing device 1 that is cut at plane III of FIG. 1. The plane III is a plane that is orthogonal to the up and down direction and passes between the arm support shaft pressing member 64 and a biasing member 58. FIG. 3 shows a cross-section as viewed from above. In FIG. 3, a rotation axis r1 and a rotation axis r2 are shown in single doted line for convenience of explanation. As shown in FIG. 3, the platen 40 has two end portions aligned along the intersection direction I, and a first side frame 44 is provided at the end portion that is positioned to the right. Similarly, a second side frame 46 is provided at the other end portion that, of the two end portions of the platen 40 aligned along the intersection direction I, is positioned to the left. The first side frame 44 and the second side frame 46 are flat plate-shaped members that surround the platen 40 from the left and right direction. The first side frame 44 and the second side frame 46 are provided in a state that the planes of the first side frame 44 and the second side frame 46 are orthogonal to the flat surface of the platen 40.

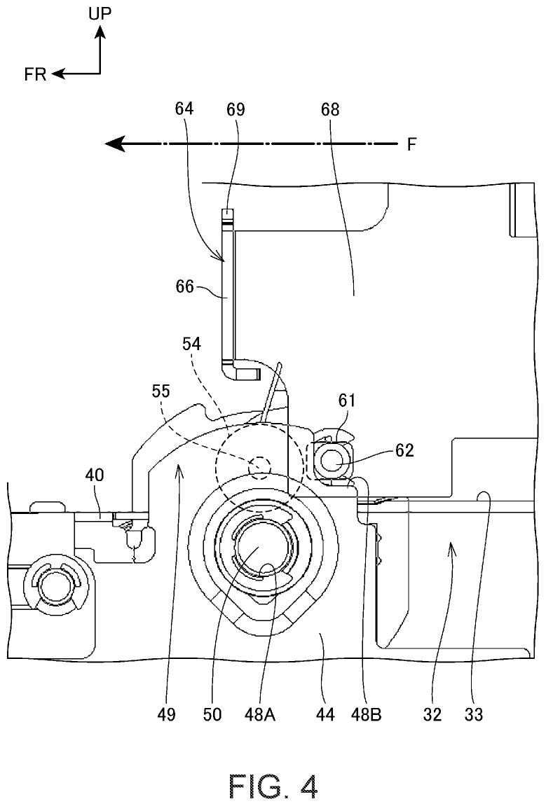

FIG. 4 is a side view of the first side frame 44 as viewed from the RH direction side. Both the first side frame 44 and the second side frame 46 have an insertion hole 48A, which is a through hole, at a portion located, as viewed from the intersection direction I, behind the rear end portion of the platen 40. Both the first side frame 44 and the second side frame 46 has a protruding portion 49 that protrudes further upward than the upper surface of the platen 40, at a position located behind the rear end portion of the platen 40. The protruding portion 49 has a notch portion 48B in the corner at the top end and rear end portions of the protruding portion 49. The notch 48 is formed by cutting off the aforementioned corner to the forward and downward directions.

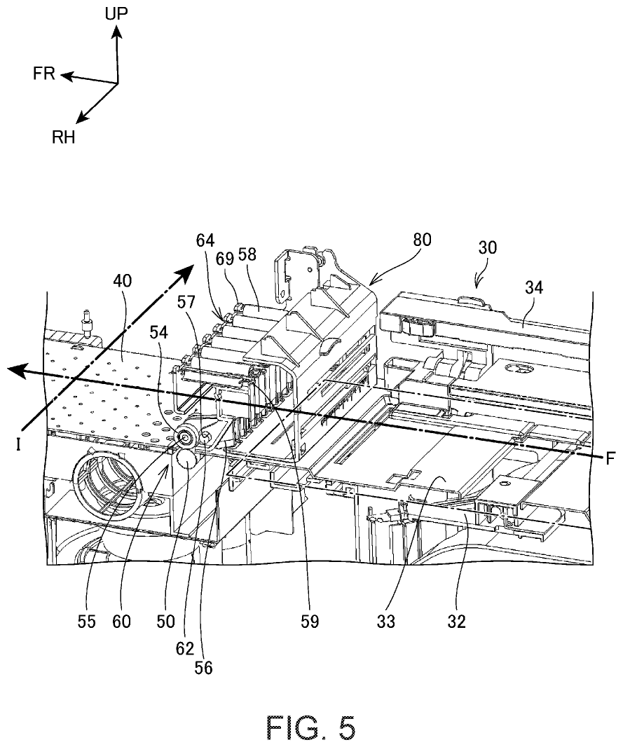

FIG. 5 is a perspective view of a longitudinal cross-section of the printing device 1 that is cut at plane V in FIG. 1. The plane V is a plane that is orthogonal to the intersection direction I and intersects the transport roller 50. FIG. 5 shows a cross-section as viewed from the RH direction side. As shown in FIG. 5, the transport section 24 has the transport roller 50, which is cylindrically shaped. The transport roller 50 extends in the longitudinal direction along the intersection direction I and is rotational in the circumferential direction. The transport roller 50 is located between the front end portion of the paper guide unit 30 and the rear end portion of the platen 40 in the transport direction F. As shown in FIG. 5, the transport roller 50 is located at a position where it contacts the front edge portion of the flat surface 33 located in the lower guide member 32.

As shown in FIG. 4, the right end portion of the transport roller 50 is inserted into the insertion hole 48A of the first side frame 44. Similarly, the left end portion of the transport roller 50 is inserted into the insertion hole 48A of the second side frame 46. By this, the transport roller 50 is supported by the first side frame 44 and the second side frame 46. In other words, the transport roller 50 is integrally provided on the platen 40 via the first side frame 44 and the second side frame 46.

As shown in FIG. 3, a driven wheel 53 is provided at one end portion of the transport roller 50. A power-transmitting belt 51 is wound around the driven wheel 53. As shown in FIG. 2, the power-transmitting belt 51 is wound around a drive shaft of the transport motor 52. By this, the transport roller 50 and the transport motor 52 are connected to each other via the power-transmitting belt 51. The transport motor 52 is a drive device that rotates and drives the transport roller 50. The transport motor 52 and the power-transmitting belt 51 are located below the platen 40.

The transport roller 50, which is driven by the transport motor 52, rotates around a rotation axis r1 that extends in the longitudinal direction of the transport roller 50 through the center of the end surface of the transport roller 50. The rotation axis r1 corresponds to a “first rotation shaft”.

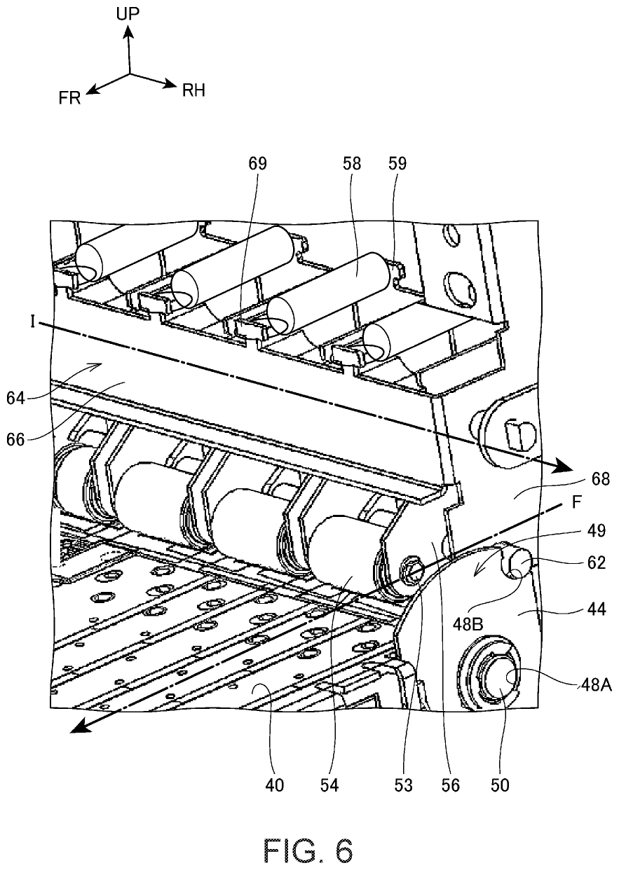

FIG. 6 is a perspective view showing the transport roller pair 60 and the platen 40. The transport section 24 has a plurality of driven rollers 54. As shown in FIG. 6, the driven rollers 54 are cylindrical in shape, and there circumferential surfaces are formed of material that has flexibility, such as a rubber material. The plurality of driven rollers 54 can rotate freely and are located along the longitudinal direction of transport roller 50. The driven rollers 54 are biased so that their circumferential surfaces the are in contact with circumferential surface of the transport roller 50. By this, the transport roller 50 and the driven rollers 54 are located in contact with each other in a state in which their respective circumferential surfaces are facing each other. As shown in FIGS. 2 and 5, the transport roller 50 is located on the lower guide member 32 side, and the driven roller 54 is located on the paper pressing member 34 side.

Note that the transport roller 50 may be located on the lower guide member 32 side, in other words, on the platen 40 side. For example, the transport section 24 may have, instead of the transport roller 50, a transport belt that can move on the upper surface of the platen 40.

In the transport section 24, the transport motor 52 is driven to rotate the transport roller 50 via the power-transmitting belt 51, then the driven roller 54 is rotated by the transport roller 50. By this, the label paper 100 between the lower guide member 32 and the paper pressing member 34 is sandwiched between the transport roller 50 and the driven roller 54 and transported to the printing section 22 by the rotational drive of the transport roller 50.

The label paper 100 that is placed on the flat surface 33 and that is fed out from the paper guide unit 30, is inserted and sandwiched between the transport roller 50 and the driven roller 54. By rotating the transport roller 50 in this state, that label paper 100 is transported to the printing section 22. In the printing device 1, the transport roller 50 and the driven roller 54 constitute a transport roller pair 60.

As described above, the plurality of driven rollers 54 are in contact with the transport roller 50 along the longitudinal direction of the transport roller 50. By this, even in the case of the print medium having unevenness in the up and down direction, such as the label paper 100 that has level differences between the labels and the base paper, an occurrence of a portion where the driven roller 54 and the print medium separate from each other over the intersection direction I is suppressed.

The driven roller 54 has a rotation shaft body 55. The rotation shaft body 55 is a rod-shaped member that passes through the center of the end surface of the driven roller 54 and that extends in the longitudinal direction of the driven roller 54. As shown in FIG. 3, the rotation shaft body 55 overlaps the rotation axis r2, which is the rotation center of the driven roller 54. The rotation axis r2 corresponds to a “second rotation shaft”.

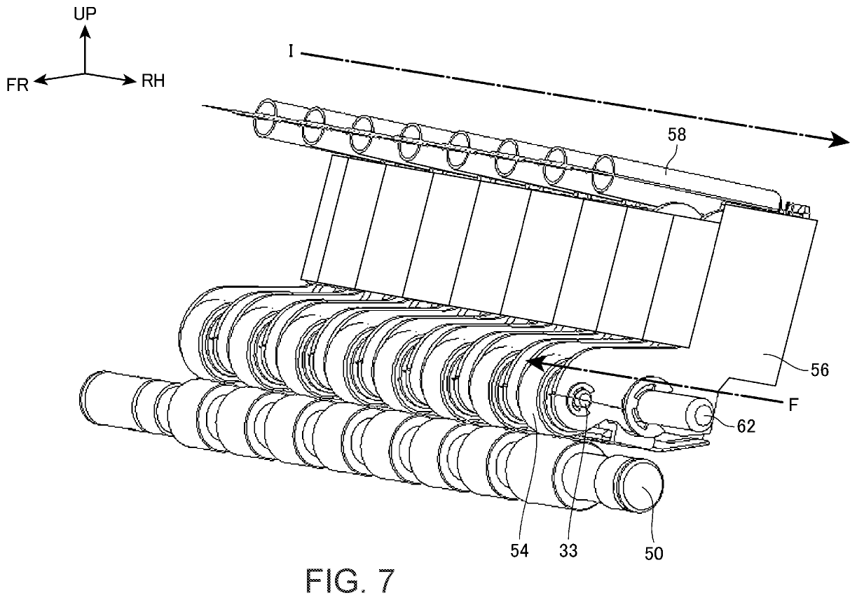

FIG. 7 is a perspective view showing the transport roller pair 60. In FIG. 7, the arm support shaft pressing member 64 is not shown. As shown in FIGS. 5 to 7, each of the driven rollers 54 is supported by the arm section 56. As shown in FIG. 6, one arm section 56 supports one driven roller 54. In other words, a plurality of arm sections 56 are provided in the printing device 1. The arm sections 56 are arranged along the longitudinal direction of the transport roller 50.

A front end portion of the arm section 56 is divided into two portions. Two of the front end portions are connected to end portions of the respective one of the driven rollers 54, which are positioned in the longitudinal direction of the rotation shaft body 55. By this, the arm section 56 rotatably supports the driven roller 54.

The arm section 56 extends further upward with greater distance from the front end toward the rear end and is a member that is formed in a substantially J-shape as viewed from the side direction. Each of the arm sections 56 is provided with an insertion hole 57, which is a through hole along intersection direction I, at a position adjacent to the driven roller 54 supported at the front end portion as view in the side direction.

A cylindrical shaped arm support shaft 62, which extends along the intersection direction I, is inserted into each of the insertion holes 57. The arm support shaft 62 has a longer distance in the longitudinal direction than the distance from the driven roller 54 at the left end to the driven roller 54 at the right end along intersection direction I. The arm support shaft 62 connects the arm sections 56 to each other. The arm support shaft 62 is located substantially parallel to the longitudinal direction of the rotation shaft body 55 and the rotation axis r2 in the longitudinal direction.

As shown in FIG. 6, the upper end portion of the arm section 56 has a connection protrusion section 59 that protrudes upward. One end portion of the biasing member 58 is connected to the connection protrusion section 59. The biasing member 58 is a so-called tension spring, and its longitudinal direction extends along the transport direction F. The other end portion of the biasing member 58 is connected to the arm support shaft pressing member 64 via the connection protrusion section 69.

As shown in FIG. 3, the arm support shaft pressing member 64 is a member formed by bending a sheet metal or other plate-shaped member into a substantially U-shape that protrudes toward the downstream side of the transport direction in the planar view The arm support shaft pressing member 64 is, for example, attached and fixed to a member that supports mechanisms of the printing device 1.

The arm support shaft pressing member 64 has a front section 66, which forms a plane that is orthogonal to the transport direction F, and a pair of side sections 68, which are orthogonal to the intersection direction I. The front section 66 is located above each of the driven rollers 54 and covers upward-extending portions of the arm sections 56 from the front side. One of the side sections 68 covers the left-most driven roller 54 and the arm sections 56 from the left side and the other of the side sections 68 covers the right-most driven roller 54 and the arm sections 56 from the right side.

As shown in FIG. 4, each of the pair of side sections 68 is provided with an insertion hole 61, which is a through hole that passes along the intersection direction I. The insertion hole 61 is an elongated hole extending along the transport direction F in the planar view. The left end portion of the arm support shaft 62 is inserted into the insertion hole 61 of the one side section 68 and the right end portion of the arm support shaft 62 is inserted into the insertion hole 61 of the other side section 68. Both the left end portion and the right end portion of the arm support shaft 62 protrude outward from the arm support shaft pressing member 64 through the insertion hole 61 by a predetermined length dimension.

As shown in FIG. 6, a plurality of upward-protruding connection protrusion sections 69 are provided at the upper end portion of the front section 66. The same number of connection protrusion sections 69 as the connection protrusion sections 59 are provided at the upper end portion of the arm support shaft pressing member 64. As described above, the other end of the biasing member 58 is connected to each of the connection protrusion sections 69.

As described above, the arm support shaft pressing member 64 is attached to the device case 10 or another member. In this state, each of the arm sections 56 is biased to approach the arm support shaft pressing member 64 along the transport direction F by the restoring force of the biasing member 58.

As shown in FIGS. 4 and 6, when the arm section 56 is biased, the circumferential surface of the right side end portion of the arm support shaft 62 contacts the notch portion 48B of the first side frame 44. Also, when the arm section 56 is biased, the circumferential surface of the left side end portion of the arm support shaft 62 contacts the notch portion 48B of the second side frame 46. Specifically, the downstream portions in the transport direction F of the circumferential surface of the left and right side end portions of the arm support shaft 62 contact the corresponding notch portions 48B. By this, the arm support shaft 62 is positioned according to the first side frame 44 and the second side frame 46, as well as the transport roller 50.

As shown in FIG. 5, an upper guide 80 is provided above the front end portion of the lower guide member 32. The upper guide 80 is formed of resin material, for example, and is a plate-shaped member that forms a substantially C-shaped shape as viewed from the intersection direction I. The upper guide 80 is located in front of the paper pressing member 34, and covers each of the arm sections 56 from the upstream side in the transport direction F. As shown in FIG. 1, the upper guide 80 is covered by the device case 10 from above and is covered by the upper cover 17 from behind. This upper guide 80 is a member in the transport path R that guides the label paper 100 from above and at the downstream side of the paper pressing member 34.

As shown in FIG. 2, the printing device 1 is provided with a label detector 70 in the transport path R. The label detector 70 detects a leading edge and a trailing edge of the label paper 100, and a leading edge and a trailing edge of the label. The label detector 70 of the present embodiment is disposed on the downstream side of the paper guide unit 30 and on the upstream side of the transport roller 50. The label detector 70 is, for example, an optical transmission type sensor that has a light emitting section 72 on the lower surface side of the label paper 100 and a light receiving section 74 on the upper surface side of the label paper 100 in the transport path R. The light emitting section 72 and the light receiving section 74 are located facing each other along the up and down direction, with a space between them to enable the label paper 100 to pass through. In other words, the light emitting section 72 and the light receiving section 74 are arranged to face each other along the thickness direction of the label paper 100. As a result, the light emitting section 72 and the light receiving section 74 are arranged at substantially the same location in the front and back direction.

The label detector 70 may be located on the downstream side of the transport roller 50 and on the upstream side of the print head 42. For example, the light emitting section 72 may be located on the lower guide member 32 side, and the light receiving section 74 may be located on the paper pressing member 34 side. In this case, the light emitting section 72 may be located on the platen 40 side, and the light receiving section 74 may be located on the print head 42 side.

In the label detector 70, the light emitting section 72 and the light receiving section 74 can be positioned where the light receiving section 74 can receive light emitted from the light emitting section 72 at a predetermined signal intensity. In this case, the output value indicating the amount of light received by the light receiving section 74 differs depending on whether there is no label paper 100, there is a base paper, or there is a label directly under the light receiving section 74. In other words, the signal intensities of the light emitted from the light emitting section 72, the light transmitted through the base paper, and the light transmitted through the label are different from each other. Therefore, the label detector 70 can detect the leading edge and the trailing edge of the label paper 100 and the leading edge and the trailing edge of the label, based on the output value indicating the amount of light received by the light receiving section 74.

As shown in FIG. 2, a cutter unit 110 is located on the downstream side of the print head 42 in the transport direction F, in other words, on the front side of the print head 42. The cutter unit 110 has a fixed blade 112 and a movable blade 114 which are located across the transport path R. The movable blade 114 is connected to a drive device such as a motor which drives the cutter via a gear or the like. In the cutter unit 110, when the motor is driven, the movable blade 114 moves toward the fixed blade 112 and cuts the label paper 100. The cutter unit 110 may cut the label paper 100 so as to leave a part of the label paper 100 uncut in the width direction, or may completely cut the label paper 100. The printing device 1 cuts the label paper 100 printed by the print head 42 to a predetermined length by the cutter unit 110 and discharges it from the paper discharge slot 14. Note that the cutter unit 110 may be formed separately from the printing device 1, and may be removable from the front surface of the printing device 1.

As shown in FIG. 2, the printing device 1 has a control substrate 18 that controls each section of the printing device 1. The control substrate 18 has a CPU, a ROM, a RAM, and the like, as the operation execution section. In the ROM of the control substrate 18, firmware executable by the CPU, data related to the firmware, and the like are stored in a nonvolatile manner. The RAM temporarily stores data and the like related to the firmware executed by the CPU. The control substrate 18 may have other peripheral circuits and the like. The control substrate 18 may have a storage section capable of storing various programs and data, such as a control program and data related to the control program, in a nonvolatile manner.

The control substrate 18 is configured to detect the operations performed on the printing device 1 and the transport amount of the label paper 100. The control substrate 18 is formed so as to be able to control the drive device provided in the printing device 1, such as the transport motor 52. In the print head 42, the control substrate 18 supplies voltage to a pump, which supplies ink from the ink tank, and to the piezoelectric elements, which is provided in the nozzle sections 41 to 47 of the print head 42, to operate them. By this, the printing device 1 forms dots by ejecting ink droplets from each of the nozzles of nozzle sections 41-47.

The control substrate 18 causes the light emitting section 72 and the light receiving section 74 to work and is formed to be able to acquire a detection value of the label detector 70. The label detector 70 works as a detection means in conjunction with the control substrate 18.

Next, the operation of the embodiment will be described. In the printing device 1, the label paper 100 accommodated in the accommodation section 20 is transported to the printing section 22 by the transport section 24, and printing is performed on each of the print surfaces of the labels on the label paper 100.

In the printing device 1, the label paper 100 is sandwiched between the transport roller pair 60, that is, the transport roller 50 and the driven roller 54, and is transported by rotation of the transport roller 50. In some previous printing devices, the transport roller 50 and the arm support shaft 62 are supported by different members from each other. In such printing devices, due to variations in assembly accuracy when the printing device is assembled, the arm support shaft 62 is sometimes installed in a state where it is not substantially parallel to the rotation axis r1 of the transport roller 50, that is, in a state where it extends in an intersecting direction.

If the label paper 100 is printed on such a printing device, there may be a difference in the feeding amount of the label paper 100 at both ends of the transport roller pair 60, for example, resulting in a difference in the transport path length. By this, in such printing device, when printing on the label paper 100 in the printing section 22, there is a possibility that the ink may not land correctly on the label and printing unevenness may occur.

In the printing device 1 in this embodiment, both the transport roller 50 and the arm support shaft 62 are supported by the first side frame 44 and the second side frame 46. By this, the printing device 1 suppresses the transport roller 50 and the arm support shaft 62 from being located in a state where they extend in directions that intersect each other. Therefore, the printing device 1 can suppress printing unevenness on the label paper 100 and improve printing accuracy.

In the printing device 1 in this embodiment, the arm support shaft 62 is positioned by the circumferential surface of the arm support shaft 62 that contacts the first side frame 44 and the second side frame 46 at the downstream side in the transport direction F. By this, for example, when performing maintenance or assembly of the printing device 1, the arm support shaft 62 can easily separate from the first side frame 44 and the second side frame 46. Therefore, it is possible to form a transport roller pair 60 while installing the transport roller 50 and the arm support shaft 62 in different units from each other, and to improve the maintainability and assemblability of the printing device 1. Further, the transport roller 50 and the arm support shaft 62 can be easily positioned.

In the printing device 1, when assembling it, the first side frame 44 or the second side frame 46 may be misaligned and the position of the transport roller 50 may extend in the intersection direction I, for example. As described above, the arm support shaft 62 is supported by the left end portion being inserted into the insertion hole 61 of one side section 68 and the right end portion being inserted into the insertion hole 61 of the other side section 68. Each of the insertion holes 61 has an elongated-shaped hole extending along the transport direction F. By this, the printing device 1 can move the position of the left end portion or the right end portion of the arm support shaft 62 along the transport direction F inside the insertion holes 61. Therefore, the printing device 1 can position the arm support shaft 62 according to the direction in which the transport roller 50 extends.

Each of the above described embodiments merely shows specific examples to which the present disclosure is applied. This disclosure is not limited to the configurations of the above embodiments, and can be implemented in various aspects without departing from the gist of the disclosure.

In the above embodiments, other devices such as a peeler that performs a process of peeling a label from a base paper and the cutter unit 110 may be provided on the front surface of the printing device 1.

In the above embodiments, the label printer is exemplified as the printing device 1. However, the printing device 1 is not limited to the label printer. The printing device 1 may be a device having a transport device that transports the print medium and a printing section 22 that performs printing on the print medium. For example, the printing device 1 may be a large format printer, a textile printing machine that performs textile printing, or the like.

In the embodiment described above, a line head type of print head is shown as an example of the print head 42, but it can also be a serial head type of print head. The printing method of the print head 42 is not limited to an ink jet type.

Directions such as horizontal and vertical directions and various shapes in the above embodiments include a so-called equivalent range in which the same effects as those of the directions and the shapes are achieved unless otherwise specified.

### Summary of Present Disclosure

Hereinafter, a summary of the present disclosure is appended.
Note 1. A printing device includes a transport roller pair that sandwiches a print medium and that transports the print medium in a transport direction; a first side frame; and a second side frame; wherein the transport roller pair includes a transport roller, a first rotation shaft that is a rotation shaft of the transport roller, a driven roller that is located at a position facing the transport roller, a second rotation shaft that is a rotation shaft of the driven roller, an arm section that rotatably holds the second rotation shaft, and an arm support shaft that extends along a direction in which the second rotation shaft extends and that supports the arm section, and the transport roller and the arm support shaft are arranged parallel to each other in a longitudinal direction, by the first side frame positioning one end portion of the arm support shaft in the longitudinal direction and by the second side frame positioning an other end portion of the arm support shaft in the longitudinal direction. By this, the printing device can improve printing accuracy.
Note 2. In the printing device according to Note 1, wherein the first side frame and the second side frame contact a part of a circumferential surface of the arm support shaft. By this, the printing device can easily separate the arm support shaft from the first side frame and the second side frame.
Note 3. The printing device according to Note 1 or 2, further including an arm support shaft pressing member that is pivotably provided around a rotation shaft, which is parallel to the first rotation shaft, and that causes the arm support shaft to contact the first side frame and the second side frame by pivoting and a biasing member that biases the arm support shaft pressing member toward the arm support shaft, wherein one end portion of the biasing member is attached to the arm support shaft pressing member and the other end portion of the biasing member is attached to the arm section. By this, the printing device can adjust the positioning of the arm support shaft by adjusting the elastic force of the biasing member.
Note 4. In the printing device according to note 3, wherein the arm support shaft pressing member is provided with an insertion hole into which the arm support shaft is inserted, the insertion hole has an elongated shape whose longitudinal direction extends in the transport direction, and the arm support shaft is supported in the insertion hole so as to be movable along the shape of the insertion hole. By this, the printing device can position the arm support shaft according to the direction in which the transport roller extends.

What is claimed is:

1. A printing device comprising:
a transport roller pair that sandwiches a print medium and that transports the print medium in a transport direction;
a first side frame; and
a second side frame; wherein
the transport roller pair includes
a transport roller,
a first rotation shaft that is a rotation shaft of the transport roller,
a driven roller that is located at a position facing the transport roller,
a second rotation shaft that is a rotation shaft of the driven roller,
an arm section that rotatably holds the second rotation shaft, and
an arm support shaft that extends along a direction in which the second rotation shaft extends and that supports the arm section, and
the transport roller and the arm support shaft are arranged parallel to each other in a longitudinal direction, by the first side frame positioning one end portion of the arm support shaft in the longitudinal direction and by the second side frame positioning an other end portion of the arm support shaft in the longitudinal direction.

2. The printing device according to claim 1, wherein
the first side frame and the second side frame contact a part of a circumferential surface of the arm support shaft.

3. The printing device according to claim 1, further comprising:
an arm support shaft pressing member that is pivotably provided around a rotation shaft, which is parallel to the first rotation shaft, and that causes the arm support shaft to contact the first side frame and the second side frame by pivoting and
a biasing member that biases the arm support shaft pressing member toward the arm support shaft, wherein
one end portion of the biasing member is attached to the arm support shaft pressing member and the other end portion of the biasing member is attached to the arm section.

4. The printing device according to claim 3, wherein
the arm support shaft pressing member is provided with an insertion hole into which the arm support shaft is inserted,
the insertion hole has an elongated shape whose longitudinal direction extends in the transport direction, and
the arm support shaft is supported in the insertion hole so as to be movable along the shape of the insertion hole.
